(19) United States
(12) Patent Application Publication
(10) Pub. No.: US 2023/0344303 A1
(43) Pub. Date: Oct. 26, 2023

(54) MOTOR AND MOTOR UNIT

(71) Applicant: NIDEC CORPORATION, Kyoto (JP)

(72) Inventors: Daisuke OGASAWARA, Kyoto (JP); Jun MURAKAMI, Kyoto (JP); Hiroki AKAISHI, Kyoto (JP); Kazuyuki YAMAMOTO, Kyoto (JP); Mizuki NIHIRA, Kyoto (JP)

(21) Appl. No.: 17/798,556

(22) PCT Filed: Sep. 14, 2020
(86) PCT No.: PCT/JP2020/034640

§ 371 Date: Aug. 10, 2022

(30) Foreign Application Priority Data
Feb. 14, 2020 (JP) 2020-023049

(51) Int. Cl. H02K 5/24; H02K 7/116; H02K 11/33

(52) U.S. Cl. CPC H02K 5/24; H02K 7/116; H02K 11/33

(57) ABSTRACT

A motor includes a rotor, a stator, a motor housing, an inverter, and an inverter case. The motor housing and the inverter case are arranged in contact with each other. The inverter case has a side wall surrounding the inverter when viewed from above. The side wall includes an upper side wall located in an upper part of the side wall, a step wall extending from a lower end of the upper side wall, and a lower side wall extending downward from an end edge of the step wall. The side wall has a plurality of outer ribs extending in the up-down direction. The outer rib is connected to the outer surface of the step wall and the outer surface of the upper side wall or the lower side wall located inside the inverter case relative to the step wall.

### CROSS-REFERENCE TO RELATED APPLICATIONS

This is the U.S. national stage of application No. PCT/JP2020/034640, filed on Sep. 14, 2020, and priority under 35 U.S.C. § 119(a) and 35 U.S.C. § 365(b) is claimed from Japanese Patent Application No. 2020-023049, filed on Feb. 14, 2020.

### FIELD OF THE INVENTION

The present invention relates to a motor and a motor unit.

### BACKGROUND

Conventionally, various countermeasures against the motor vibration have been known. For example, a method of reducing an excitation force that excites vibration and a method of reducing vibration in a motor attachment part are known.

A motor unit used as a drive device for a vehicle is configured by combining a motor, a gear, an inverter, and the like. In such a motor unit, vibration of the motor is transmitted to the inverter case, and noise due to membrane resonance of the inverter case may be generated.

### SUMMARY

According to one exemplary aspect of the present invention, there is provided a motor including a rotor and a stator, a motor housing that accommodates the rotor and the stator, an inverter that is electrically connected to the stator, and an inverter case that accommodates the inverter. The motor housing and the inverter case are arranged in contact with each other. The inverter case has a side wall surrounding the inverter when viewed from above. The side wall includes an upper side wall that is located in an upper part of the side wall, a step wall that extends from a lower end of the upper side wall to an inside or an outside of the inverter case, and a lower side wall that extends downward from an end edge of the step wall. The inverter case has a plurality of outer ribs that extend in an up-down direction on an outer surface of the side wall. The outer rib is connected to an outer surface of the step wall and an outer surface of the upper side wall or an outer surface of the lower side wall that is located inside the inverter case relative to the step wall.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic configuration view of a motor unit according to an embodiment;

FIG. 2 is a schematic external view of the motor unit according to the embodiment;

FIG. 3 is a perspective view of a case body of the inverter case as viewed from below;

FIG. 4 is a perspective view of the case body of the inverter case as viewed from above; and

FIG. 5 is a partial cross-sectional view of the case body at a position along line V-V in FIG. 4.

### DETAILED DESCRIPTION

The following description will be made with the direction of gravity being defined on the basis of positional relationships in the case where a motor unit 1 is mounted in a vehicle on a horizontal road surface. In the drawings, an XYZ coordinate system is shown appropriately as a three-dimensional orthogonal coordinate system. In the XYZ coordinate system, a Z-axis direction corresponds to a vertical direction (i.e., an up-down direction), and a +Z direction points upward (i.e., in a direction opposite to the direction of gravity), while a −Z direction points downward (i.e., in the direction of gravity). An X-axis direction corresponds to a front-rear direction of the vehicle in which the motor unit 1 is mounted, and is a direction orthogonal to the Z-axis direction, and a +X direction points forward of the vehicle, while a −X direction points rearward of the vehicle.

However, the +X direction and the −X direction may point rearward and forward, respectively, of the vehicle. A Y-axis direction is a direction orthogonal to both the X-axis direction and the Z-axis direction and indicates a width direction (left-right direction) of the vehicle, and a +Y direction points leftward of the vehicle, while a −Y direction points rightward of the vehicle. However, when the +X direction points rearward of the vehicle, the +Y direction may point rightward of the vehicle, and the −Y direction may point leftward of the vehicle. That is, the +Y direction simply points to one side in the left-right direction of the vehicle, and the −Y direction points to the other side in the left-right direction of the vehicle, regardless of the direction of the X-axis.

In description below, unless otherwise specified, a direction (that is, the Y-axis direction) parallel to a motor axis J2 of a motor 2 will be simply referred to by the term “axial direction”, “axial”, or “axially”, radial directions around the motor axis J2 will be simply referred to by the term “radial direction”, “radial”, or “radially”, and a circumferential direction around the motor axis J2, that is, a circumferential direction about the motor axis J2, will be simply referred to by the term “circumferential direction”, “circumferential”, or “circumferentially”. However, the term “parallel” as used above includes both “parallel” and “substantially parallel”.

The motor unit 1 of the present embodiment is mounted on a vehicle using a motor as a power source, such as a hybrid electric vehicle (HEV), a plug-in hybrid electric vehicle (PHV), or an electric vehicle (EV), and is used as the power source.

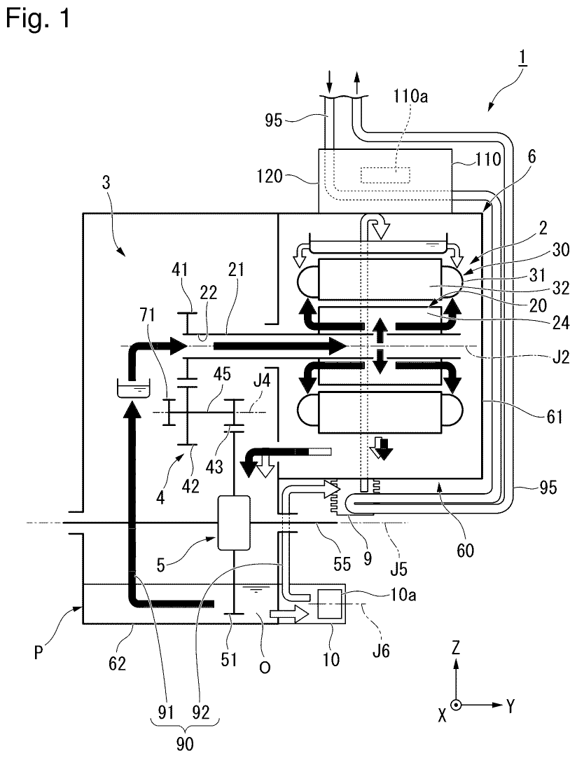

As illustrated in FIG. 1, the motor unit 1 includes the motor 2, a transmission mechanism 3, a housing 6, oil O accommodated in the housing 6, an oil cooler 9, and an inverter device 110.

The motor 2 includes a rotor 20 that rotates about the motor axis J2 extending in the horizontal direction, and a stator 30 located radially outside the rotor 20.

The housing 6 includes a motor housing 60 that accommodates the motor 2, a motor cover 61 that closes an end part on one side (−Y side) of the motor housing 60, and a gear housing 62 that is located at an end part on the other side (+Y side) of the motor housing 60 and accommodates the transmission mechanism 3.

The motor 2 is an inner rotor type motor. The rotor 20 is arranged radially inside the stator 30. The rotor 20 includes a shaft 21, a rotor core 24, and a rotor magnet (not illustrated). The motor 2 may be an outer rotor type motor.

The shaft 21 is arranged about the motor axis J2 extending in a horizontal direction and in a width direction of a vehicle. The shaft 21 is a hollow shaft having a hollow part 22 inside. The shaft 21 protrudes from the motor housing 60 into the gear housing 62. An end part of the shaft 21 protruding to the gear housing 62 is coupled to the transmission mechanism 3. Specifically, the shaft 21 is coupled to a first gear 41 of the transmission mechanism 3.

The stator 30 encloses the rotor 20 from radially outside. The stator 30 includes a stator core 32, a coil 31, and an insulator (not illustrated) interposed between the stator core 32 and the coil 31. The stator 30 is held by the motor housing 60. The coil 31 is connected to the inverter device 110 directly or via a bus bar (not illustrated).

The transmission mechanism 3 is accommodated in the gear housing 62. The transmission mechanism 3 is connected to the shaft 21 on one side in the axial direction of the motor axis J2. The transmission mechanism 3 includes a reduction gear 4 and a differential gear 5. Torque output from the motor 2 is transmitted to the differential gear 5 through the reduction gear 4.

The reduction gear 4 is connected to the shaft 21 of the motor 2. The reduction gear 4 has the first gear 41, a second gear 42, a third gear 43, and an intermediate shaft 45. The first gear 41 is coupled to the shaft 21 of the motor 2. The intermediate shaft 45 extends along an intermediate axis J4 parallel to the motor axis J2. The second gear 42 and the third gear 43 are fixed to both ends of the intermediate shaft 45. The second gear 42 and the third gear 43 are connected to each other via the intermediate shaft 45. The second gear 42 meshes with the first gear 41. The third gear 43 meshes with a ring gear 51 of the differential gear 5.

Torque output from the motor 2 is transmitted to the ring gear 51 of the differential gear 5 through the shaft 21 of the motor 2, the first gear 41, the second gear 42, the intermediate shaft 45, and the third gear 43. A gear ratio of each gear, the number of gears, and the like can be modified in various manners in accordance with a required reduction ratio. The reduction gear 4 is a speed reducer of a parallel-axis gearing type, in which axis centers of gears are arranged in parallel with one another.

The differential gear 5 transmits torque output from the motor 2 to an axle of a vehicle. The differential gear 5 transmits the torque to axles 55 of both the left and right wheels while absorbing the speed difference between the left and right wheels when the vehicle turns. The differential gear 5 includes a gear housing, a pinion gear, a pinion shaft, and a side gear (all not illustrated) in addition to the ring gear 51 meshing with the third gear of the reduction gear 4.

A lower region in the gear housing 62 is provided with an oil reservoir P in which the oil O accumulates. In the present embodiment, a bottom part of the motor housing 60 is located at a higher level than a bottom part of the gear housing 62. With this configuration, the oil O after the motor 2 is cooled can be easily collected from a lower region of the motor housing 60 to the oil reservoir P of the gear housing 62.

A part of the differential gear 5 soaks in the oil reservoir P. The oil O accumulated in the oil reservoir P is scraped up by operation of the differential gear 5. A part of the scraped oil O is supplied into the shaft 21. Another part of the oil O is diffused into the gear housing 62 and supplied to each gear of the reduction gear 4 and the differential gear 5. The oil O used for lubrication of the reduction gear 4 and the differential gear 5 is dropped and collected in the oil reservoir P located on the lower side of the gear housing 62.

The inverter device 110 includes an inverter 110a electrically connected to the motor 2 and an inverter case 120 accommodating the inverter 110a. The inverter 110a controls current to be supplied to the motor 2. The inverter case 120 is fixed to the motor housing 60. A cooling water pipe 95 extending from a radiator of the vehicle is connected to the inverter device 110. The cooling water pipe 95 extends to the oil cooler 9 via the inverter device 110.

The oil cooler 9 is located on a side surface of the motor housing 60. The cooling water pipe 95 extending from the inverter device 110 is connected to the oil cooler 9. The oil O discharged from an electric oil pump 10 is supplied to the oil cooler 9. The oil O passing through the inside of the oil cooler 9 is cooled through heat exchange with cooling water passing through the cooling water pipe 95. The oil O cooled by the oil cooler 9 is supplied to the motor 2.

The electric oil pump 10 is an oil pump driven by a pump motor 10a. The electric oil pump 10 sucks up the oil O from the oil reservoir P and supplies the oil O to the oil cooler 9. The pump motor 10a rotates a pump mechanism of the electric oil pump 10. In the motor unit 1, a rotation axis J6 of the pump motor 10a is parallel to the motor axis J2. The electric oil pump 10 having the pump motor 10a tends to become long in a direction in which the rotation axis J6 extends. By making the rotation axis J6 of the pump motor 10a parallel to the motor axis J2, the electric oil pump 10 becomes less likely to protrude in the radial direction of the motor unit 1. This makes it possible to reduce the radial dimension of the motor unit 1.

As illustrated in FIG. 1, the oil O circulates in an oil passage 90 provided in the housing 6. The oil passage 90 is a path of the oil O for supplying the oil O from the oil reservoir P to the motor 2. The oil O circulating in the oil passage 90 is used as lubricating oil for the reduction gear 4 and the differential gear 5 and as cooling oil for the motor 2. The oil O accumulates in the oil reservoir P in a lower part of the gear housing 62. Oil equivalent to automatic transmission fluid (ATF) having a low viscosity is preferably used as the oil O so that the oil O can perform functions of lubricating oil and cooling oil.

As illustrated in FIG. 1, the oil passage 90 is a path of the oil O that is guided from the oil reservoir P on the lower side of the motor 2 to the oil reservoir P on the lower side of the motor 2 again via the motor 2. The oil passage 90 includes a first oil passage 91 passing through the inside of the motor 2 and a second oil passage 92 passing through the outside of the motor 2. The oil O cools the motor 2 from the inside and the outside through the first oil passage 91 and the second oil passage 92.

The oil O is scraped up by the differential gear 5 from the oil reservoir P, and is guided into an interior of the rotor 20 through the first oil passage 91. The oil O is sprayed from the rotor 20 toward the coil 31 to cool the stator 30. The oil O having cooled the stator 30 moves to the oil reservoir P of the gear housing 62 via the lower region of the motor housing 60.

In the second oil passage 92, the oil O is pumped up from the oil reservoir P by the electric oil pump 10. The oil O is pumped up to an upper part of the motor 2 via the oil cooler 9 and is supplied to the motor 2 from the upper side of the motor 2. The oil O having cooled the motor 2 moves to the oil reservoir P of the gear housing 62 via the lower region of the motor housing 60.

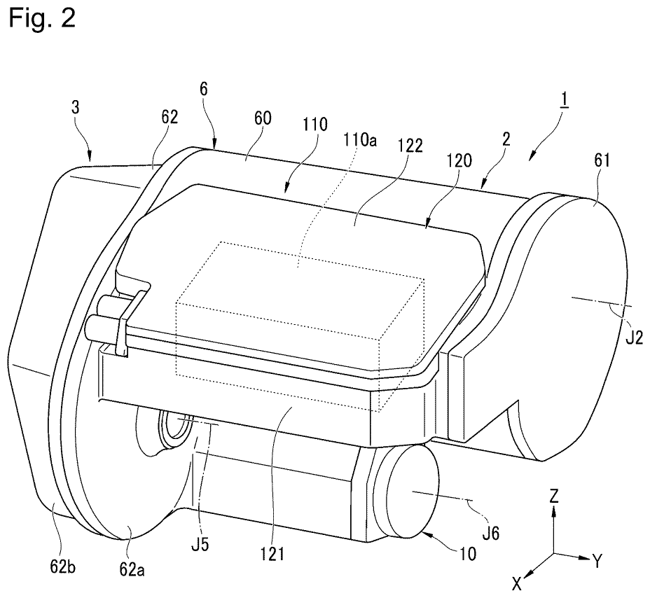

As illustrated in FIGS. 1 and 2, the inverter device 110 includes the inverter 110a and the inverter case 120 accommodating the inverter 110a inside the inverter case 120. The inverter case 120 includes a box-shaped case body 121 that opens upward, and a cover 122 that closes an opening of the case body 121 from above.

As illustrated in FIG. 2, the case body 121 is continuous to the outer peripheral surface of the motor housing 60. The case body 121 is located on the vehicle front side (+X side) of the motor housing 60. In the motor unit 1, the case body 121 and the motor housing 60 are a part of a single die casting member.

That is, the inverter case 120 and the motor housing 60 have a site formed of a common single member. When the inverter case 120 and the motor housing 60 are screwed together, the screwed site serves as a node of vibration, and the vibration of the inverter case 120 may increase. According to the present embodiment, it is easy to suppress vibration of the inverter case 120 caused by screw fastening, and the number of components can also be reduced.

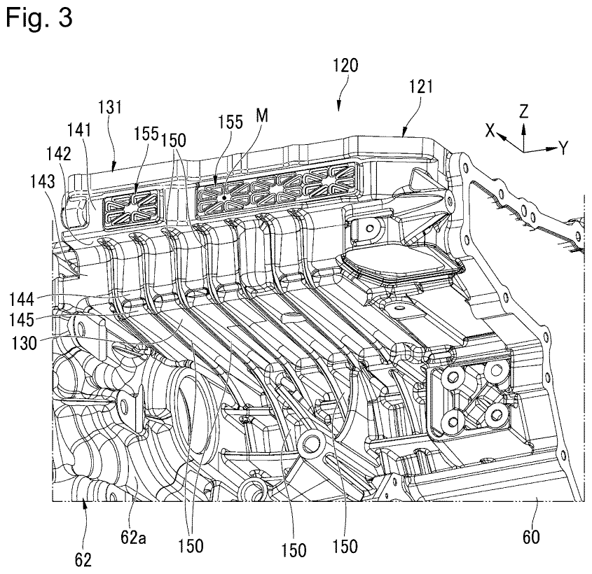

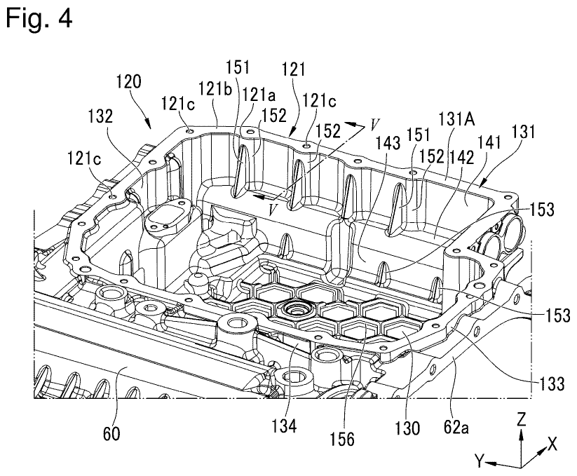

As illustrated in FIGS. 3 and 4, the case body 121 has a bottom wall 130 extending in a substantially horizontal direction and a plurality of side walls 131, 132, 133, and 134 surrounding the bottom wall 130 when viewed from above. The case body 121 has an annular sealing surface 121b formed of a flat surface facing upward around an opening 121a that opens upward. The case body 121 has a plurality of screw holes 121c that are opened to the annular sealing surface 121b and extend downward.

An end part of the bottom wall 130 on the vehicle front side (+X side) is continuous to the lower end of the side wall 131. An end part of the bottom wall 130 on the vehicle left side (+Y side) is continuous to the lower end of the side wall 132. An end part of the bottom wall 130 on the vehicle right side (−Y side) is continuous to the lower end of the side wall 133. An end part of the bottom wall 130 on the vehicle rear side (−X side) is continuous to the outer peripheral surface of the motor housing 60. The end part of the bottom wall 130 on the vehicle rear side may be configured to be continuous to the side wall 134.

The side wall 131 is located at an end part of the inverter case 120 on the vehicle front side (+X side). The side wall 132 is located at an end part of the inverter case 120 on the vehicle left side (+Y side). The side wall 133 is located at an end part of the inverter case 120 on the vehicle right side (−Y side). The side wall 134 is located at an end part of the inverter case 120 on the vehicle rear side (−X side). When viewed from above, the side walls 131 to 134 surround the inverter 110a accommodated in the inverter case 120 from all directions.

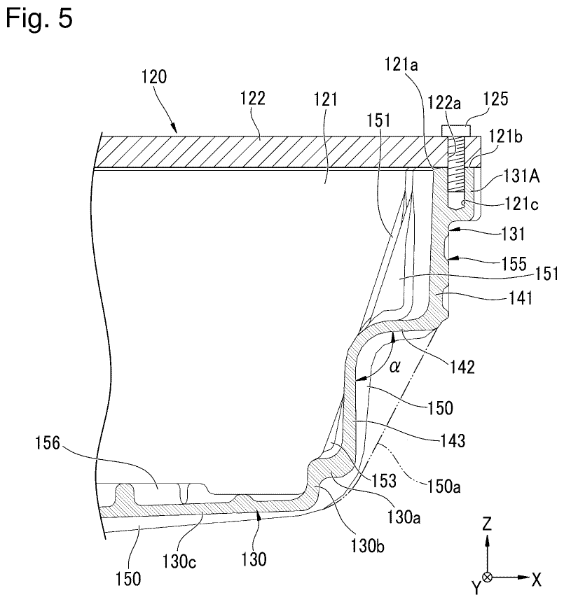

As illustrated in FIGS. 3 and 5, the side wall 131 includes an upper side wall 141 located in an upper part of the side wall 131, a step wall 142 extending from a lower end of the upper side wall 141 to the inside (−X side) of the inverter case 120, and a lower side wall 143 extending downward from an inner end edge of the step wall 142. The lower end of the lower side wall 143 is continuous to an end part of the bottom wall 130 on the vehicle rear part side.

In the case of the present embodiment, as illustrated in FIG. 5, the bottom wall 130 has a step shape at a connection site with the lower side wall 143. More specifically, the bottom wall 130 includes a peripheral edge wall 130a, a bottom side wall 130b, and a bottom wall body 130c. The peripheral edge wall 130a extends inward from the lower end of the lower side wall 143. The bottom side wall 130b extends downward from the inner end part of the peripheral edge wall 130a. The bottom wall body 130c extends along the horizontal direction from the lower end of the bottom side wall 130b. The bottom wall 130 may be configured not to have the peripheral edge wall 130a and the bottom side wall 130b.

In the side wall 131, a surface of the upper side wall 141 facing the vehicle front side (+X side) protrudes to the vehicle front side relative to a surface of the lower side wall 143 facing the vehicle front side. In the present embodiment, the side wall 131 has a flange part 131A at the upper end part of the upper side wall 141, the flange part protruding toward the vehicle front side relative to the surface of the upper side wall 141 facing the vehicle front side. The side wall 131 may be configured not to have the flange part 131A.

The side wall 131 has a plurality of outer ribs 150 that are connected to the surface of the step wall 142 facing downward and the outer surface of the lower side wall 143 and extend in the up-down direction. That is, the inverter case 120 has the plurality of outer ribs 150 that are connected to the surface of the step wall 142 facing downward and the outer surface of the lower side wall 143 and extend in the up-down direction. The inverter case 120 has seven outer ribs 150 arranged in the vehicle left-right direction (Y-axis direction).

According to this configuration, it is possible to suppress membrane vibration of the side wall 131 having the step shape, and it is possible to suppress generation of noise. Since the side wall 131 is a wall extending in the up-down direction while bending in the vehicle front-rear direction, the length along the wall surface is larger than the height of the side wall 131 in the up-down direction. When vibration is transmitted to the side wall 131, the step wall 142 and the lower side wall 143 vibrate in a direction where an angle α formed by the step wall 142 and the lower side wall 143 illustrated in FIG. 5 increases or decreases. Therefore, as in the present embodiment, by connecting the surface of the step wall 142 and the surface of the lower side wall 143 by the outer rib 150 extending in the up-down direction, it is possible to suppress the movement of the step wall 142 and the lower side wall 143 in the direction where the angle α increases or decreases. This makes it possible to suppress membrane vibration of the side wall 131, and possible to suppress generation of noise from the inverter case 120.

In the present embodiment, the outer rib 150 is configured to be connected to the step wall 142 and the lower side wall 143, but the position of the outer rib 150 can be changed depending on the configuration of the side wall 131. For example, in the side wall 131, when the upper side wall 141 is located inside the inverter case 120 relative to the lower side wall 143, the step wall 142 is configured to extend from the lower end of the upper side wall 141 to the vehicle front side (+X side). In this case, since the upper surface of the step wall 142 faces the outside of the inverter case 120, the outer rib 150 is connected to the upper surface of the step wall 142 and the upper side wall 141. That is, the outer rib 150 is connected to the outer surface of one of the upper side wall 141 and the lower side wall 143 that is located inside the inverter case 120.

In the present embodiment, the side wall 131 on which the outer rib 150 is arranged is located on the opposite side of the motor housing 60 across the inverter 110a in the inverter case 120. Unlike the other side walls 132, 133, and 134, the side wall 131 is a side wall that is not connected to the motor housing 60, and is located at a position farthest from the motor housing 60. Upper and lower parts of the side wall 131 are connected to the plate-shaped cover 122 and the bottom wall 130. Therefore, the side wall 131 is less likely to secure rigidity compared with the other side walls 132 to 134, and membrane vibration is likely to occur. In the present embodiment, vibration of the entire inverter case 120 is effectively suppressed by providing the outer rib 150 on the side wall 131 that easily vibrates.

In the present embodiment, the outer rib 150 is a rod-shaped rib. That is, the outer rib 150 has a width and a height that are substantially equivalent in length. The shape of the outer rib 150 is not particularly limited. For example, as illustrated by the imaginary line in FIG. 5, the outer rib 150 may be a rib having a protrusion height larger than that of the rod-shaped rib, such as a plate-shaped rib 150a having a triangular shape when viewed from the side surface.

As illustrated in FIGS. 3 and 5, the outer rib 150 extends from above the surface of the lower side wall 143, through above the surfaces of the peripheral edge wall 130a and the bottom side wall 130b, to above the surface facing downward of the bottom wall 130. The outer rib 150 extends from an end part of the bottom wall 130 on the vehicle front side (+X side) to an end part on the vehicle rear side (−X side). According to this configuration, the membrane vibration of the bottom wall 130 can be suppressed by the outer rib 150, and the noise generated from the bottom wall 130 can be reduced.

In the present embodiment, since the outer rib 150 extends from the surface facing the outside of the side wall 131 to above the surface facing downward of the bottom wall 130, it is also possible to suppress the side wall 131 and the bottom wall 130 from vibrating about a corner part where the side wall 131 and the bottom wall 130 are connected. This can reduce vibration and noise of the inverter case 120.

In the present embodiment, as illustrated in FIG. 3, the outer rib 150 extends to above the outer peripheral surface of the motor housing 60 through the surface of the bottom wall 130 facing downward. According to this configuration, the membrane vibration of the motor housing 60 can be suppressed by the outer rib 150, and the generation of noise from the motor housing 60 can be suppressed. Since the outer rib 150 extends across the connection site between the bottom wall 130 and the motor housing 60, it is possible to suppress the bottom wall 130 and the motor housing 60 from vibrating about the connection site between the bottom wall 130 and the motor housing 60. Since the end part of the outer rib 150 is fixed to the motor housing 60, the rigidity of the outer rib 150 on the bottom wall 130 is improved, and the vibration suppression effect of the bottom wall 130 is enhanced.

The side wall 132 extends in the vehicle front-rear direction. The end part of the side wall 132 on the vehicle front side is continuous to an end part of the side wall 131 on the vehicle left side. The end part of the side wall 132 on the vehicle rear side is continuous to the outer peripheral surface of the motor housing 60. The side wall 133 extends in the vehicle front-rear direction. The end part of the side wall 133 on the vehicle front side is continuous to an end part of the side wall 131 on the vehicle right side. The end part of the side wall 133 on the vehicle rear side is continuous to the outer peripheral surface of the motor housing 60.

The outer surface (surface facing the −Y side) of the side wall 133 is continuous to a part of the gear housing 62 located on the vehicle left side. More specifically, as illustrated in FIG. 2, the gear housing 62 has a configuration in which a left side case 62a and a right side case 62b are screwed together. In the present embodiment, the left side case 62a of the gear housing 62, the case body 121, and the motor housing 60 are a part of a single die casting member.

As illustrated in FIGS. 4 and 5, the inverter case 120 includes a plurality of upper inner ribs 151 connected to the inner surface of the upper side wall 141 and the surface of the step wall 142 facing upward and extending in the up-down direction. The upper inner rib 151 is located at a corner part where the upper side wall 141 and the step wall 142 are connected. The upper inner rib 151 is a plate-shaped rib having a triangular shape when viewed from the side surface. The inverter case 120 has four upper inner ribs 151 arranged along the vehicle left-right direction (Y-axis direction).

According to the above configuration, the upper side wall 141 and the step wall 142 are fixed to each other by the upper inner rib 151. This makes it possible to suppress vibration of the upper side wall 141 and the step wall 142 about the connection site between the upper side wall 141 and the step wall 142. The membrane vibration of the side wall 131 can be suppressed, and the noise generated from the side wall 131 can be reduced.

The inverter case 120 has a plurality of rod-shaped ribs 152 protruding inward from the inner surface of the upper side wall 141 and extending in the up-down direction. That is, the upper side wall 141 has a partially large thickness at a position provided with the rod-shaped rib 152. In the case of the present embodiment, a screw hole 121c opens on the annular sealing surface 121b at the upper end position of the rod-shaped rib 152. That is, the rod-shaped rib 152 is also a boss having the screw hole 121c. The upper inner rib 151 is connected to a surface (−X side surface) facing the inside of the rod-shaped rib 152.

According to the above configuration, since the upper inner rib 151 is connected to a base part of the boss having the screw hole 121c, the support strength of the rod-shaped rib 152 functioning as a boss can be increased. It is possible to suppress deformation or the like from occurring in the step wall 142 and the upper side wall 141 around the rod-shaped rib 152.

As illustrated in FIGS. 4 and 5, the inverter case 120 has a plurality of lower inner ribs 153 that are connected to the inner surface of the lower side wall 143 and a surface of the bottom wall 130 facing upward and extend in the up-down direction. In the case of the present embodiment, the lower inner rib 153 is connected to the surface of the bottom wall 130 facing upward of the peripheral edge wall 130a. The lower inner rib 153 is located at a corner part where the lower side wall 143 and the bottom wall 130 are connected. The lower inner rib 153 is a rod-shaped rib having a triangular shape when viewed from the side surface. The lower inner rib 153 may be a plate-shaped rib. The inverter case 120 has four lower inner ribs 153 arranged along the vehicle left-right direction (Y-axis direction). The lower inner rib 153 may extend to a lower side compared with the peripheral edge wall 130a. That is, the lower inner rib 153 may be connected to a surface facing the inside (−X side) of the bottom side wall 130b, or may be connected to a surface facing upward of the bottom wall body 130c. The lower inner rib 153 may be continuous to a honeycomb-shaped rib 156. Furthermore, the lower inner rib 153 may extend upward, and the lower inner rib 153 may be continuous to the upper inner rib 151 at the upper end part. According to the configuration in which the lower inner rib 153 is continuous to the honeycomb-shaped rib 156, the membrane vibration of the bottom wall 130 can be suppressed, and the noise generated from the inverter case 120 can be reduced.

According to the configuration of the present embodiment, the lower side wall 143 and the bottom wall 130 (peripheral edge wall 130a) are fixed to each other by the lower inner rib 153. This makes it possible to suppress vibration of the lower side wall 143 and the bottom wall 130 about the connection site between the lower side wall 143 and the bottom wall 130. The membrane vibration of the side wall 131 and the bottom wall 130 can be suppressed, and the noise generated from the inverter case 120 can be reduced.

The inverter case 120 has a rib structure 155 in which polygonal annular ribs are periodically arrayed on a surface of the upper side wall 141 facing the vehicle front side (+X). In the present embodiment, four rib structures 155 are arranged in the left-right direction on the outer surface of the upper side wall 141. In the case of the present embodiment, the rib structure 155 has a shape in which triangular annular ribs are arranged without a gap in the plane direction in plan view.

The rib structure 155 includes, for example, eight triangular annular ribs. Each of these eight annular ribs has a triangular shape. The triangular annular ribs are arrayed in such an orientation that one of the three vertices gathers about a point M in FIG. 3.

In the present embodiment, the shape of the annular rib constituting the rib structure 155 is a substantially right triangle. In the rib structure 155, the annular ribs arranged next to each other have a line-symmetric shape with respect to a symmetry axis located between them.

According to the above configuration, the membrane vibration of the upper side wall 141 can be suppressed by the rib structure 155, and the noise generated from the inverter case 120 can be reduced. The rib structure 155 may be located on the outer surface of the lower side wall 143 or may be located on a surface of the step wall 142 facing downward. That is, the rib structure 155 only needs to be located on the outer surface of the side wall 131, and can be arranged at one or more places of the upper side wall 141, the step wall 142, and the lower side wall 143.

As illustrated in FIG. 4, the inverter case 120 has the honeycomb-shaped rib 156 on the surface of the bottom wall 130 facing upward. The rib 156 constitutes a honeycomb structure. The honeycomb structure is advantageous in that flexural strength and compressive strength are high as compared with a structure in which other polygonal ribs are arrayed without a gap. Therefore, the rigidity of the bottom wall 130 can be improved. This makes it possible to further reduce the vibration of the inverter case 120. The honeycomb-shaped rib 156 can easily secure the rigidity of the bottom wall 130 even if the protrusion height from the bottom wall 130 is made relatively low. Therefore, it is possible to secure a large accommodation space in the inverter case 120 by suppressing the protrusion height of the honeycomb-shaped rib 156. This makes it possible to avoid an increase in size of the inverter case 120.

The cover 122 is a plate-like member that covers, from above, the inverter 110a accommodated in the case body 121. As illustrated in FIG. 5, the cover 122 has a through hole 122a penetrating the peripheral edge part of the cover 122 in the up-down direction. The cover 122 is arranged in contact with the annular sealing surface 121b of the case body 121. The through hole 122a is arranged on the screw hole 121c of the case body 121. A screw 125 is inserted into the screw hole 121c of the case body 121 through the through hole 122a. The cover 122 is screwed into the case body 121 by the screw 125.

In the above embodiment, the motor unit 1 including the motor 2, the transmission mechanism 3, and the inverter device 110 has been described, but the motor unit 1 may be configured to include only the motor 2 and the inverter device 110. That is, the embodiment of the present invention can also be configured as a motor including the rotor 20, the stator 30, the motor housing 60 that accommodates the rotor 20 and the stator 30, and the inverter device 110 arranged in contact with the motor housing 60.

In the motor, the motor housing 60 and the inverter case 120 may be a part of a single die casting member similarly to the previous embodiment. Alternatively, the motor housing 60 and the inverter case 120 formed of separate members from each other may be included. Even if the inverter case 120 and the motor housing 60 are separate components, when they are arranged in contact with each other, vibration of the motor is transmitted to the inverter case 120. Since the inverter device 110 includes the outer rib 150 on the side wall 131, vibration of the inverter case 120 can be suppressed, and generation of noise can be reduced.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor comprising:
a rotor and a stator;
a motor housing that accommodates the rotor and the stator;
an inverter that is electrically connected to the stator; and
an inverter case that accommodates the inverter,
wherein the motor housing and the inverter case are arranged in contact with each other,
the inverter case has a side wall surrounding the inverter when viewed from above,
the side wall includes
an upper side wall that is located in an upper part of the side wall,
a step wall that extends from a lower end of the upper side wall to an inside or an outside of the inverter case, and
a lower side wall that extends downward from an end edge of the step wall,
the inverter case has a plurality of outer ribs that extend in an up-down direction on an outer surface of the side wall, and
the outer rib is connected to an outer surface of the step wall and an outer surface of the upper side wall or an outer surface of the lower side wall that is located inside the inverter case relative to the step wall.

2. The motor according to claim 1, wherein
the inverter case has a bottom wall that extends in a horizontal direction from a lower end of the lower side wall, and
the outer rib extends through the outer surface of the lower side wall to above a surface facing a lower side of the bottom wall.

3. The motor according to claim 2, wherein
the bottom wall is connected to an outer peripheral surface of the motor housing, and
the outer rib extends to the outer peripheral surface of the motor housing through the surface facing the lower side of the bottom wall.

4. The motor according to claim 1, wherein the inverter case has a plurality of upper inner ribs that are connected to an inner surface of the upper side wall and a surface of the step wall facing upward and extend in an up-down direction.

5. The motor according to claim 4, wherein
the inverter case has a plurality of rod-shaped ribs that protrude inward from an inner surface of the upper side wall and extend in an up-down direction, and
the upper inner rib is connected to a surface of the rod-shaped rib.

6. The motor according to claim 5, wherein
the inverter case has a box-shaped case body that opens upward and a cover that closes an opening of the case body from above,
the case body has the upper side wall, the step wall, and the lower side wall,
the upper side wall has a screw hole opened upward on an upper end surface of the upper side wall, and
the screw hole is located at an upper end of the rod-shaped rib.

7. The motor according to claim 1, wherein
the inverter case has
a bottom wall that extends along a horizontal direction at a lower end part of the lower side wall, and
a plurality of lower inner ribs that are connected to an inner surface of the lower side wall and a surface facing upward of the bottom wall and extend in an up-down direction.

8. The motor according to claim 1, wherein the inverter case has a rib structure in which polygonal annular ribs are periodically arrayed on the outer surface of the side wall.

9. The motor according to claim 1, wherein the inverter case has a bottom wall that expands in a horizontal direction from the lower end of the lower side wall, and has a honeycomb-shaped rib on the surface facing upward of the bottom wall.

10. The motor according to claim 1, wherein the inverter case and the motor housing have a site formed of a common single member.

11. The motor according to claim 1, wherein the side wall that has the outer rib is located on a side opposite to the motor housing across the inverter.

12. A motor unit comprising:
the motor according to claim 1; and
a transmission mechanism that couples the motor and an axle.
